(19) United States
(12) Patent Application Publication
(10) Pub. No.: US 2013/0298407 A1
(43) Pub. Date: Nov. 14, 2013

(54) Razor Assembly

(71) Applicant: Jose A. Ramirez, Victorville, CA (US)

(72) Inventor: Jose A. Ramirez, Victorville, CA (US)

(21) Appl. No.: 13/467,008

(22) Filed: May 8, 2012

(51) Int. Cl. B26B 21/52

(52) U.S. Cl. 30/50

(57) ABSTRACT

A razor assembly provides a fixed blade razor having a peripheral blade edge extending fully around the head to facilitate shaving at various angles. The assembly includes a handle having a grip section and an extension section. A head is coupled to the extension section. A plurality of blades is coupled to the head. Each blade has a sharp peripheral edge extending fully around the blade. The sharp peripheral edge of each blade is outwardly positioned with respect to an outermost edge of the head.

### BACKGROUND OF THE DISCLOSURE

Field of the Disclosure

The disclosure relates to razor devices and more particularly pertains to a new razor device for providing a fixed blade razor having a peripheral blade edge extending fully around the head to facilitate shaving at various angles.

### SUMMARY OF THE DISCLOSURE

An embodiment of the disclosure meets the needs presented above by generally comprising a handle having a grip section and an extension section. A head is coupled to the extension section. A plurality of blades is coupled to the head. Each blade has a sharp peripheral edge extending fully around the blade. The sharp peripheral edge of each blade is outwardly positioned with respect to an outermost edge of the head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a razor assembly according to an embodiment of the disclosure.

FIG. 2 is a top view of an embodiment of the disclosure.

FIG. 3 is a back view of an embodiment of the disclosure.

FIG. 4 is a side view of an embodiment of the disclosure.

FIG. 5 is a cross-sectional view of an embodiment of the disclosure taken along line 5-5 of FIG. 2.

### DESCRIPTION OF THE PREFERRED EMBODIMENT

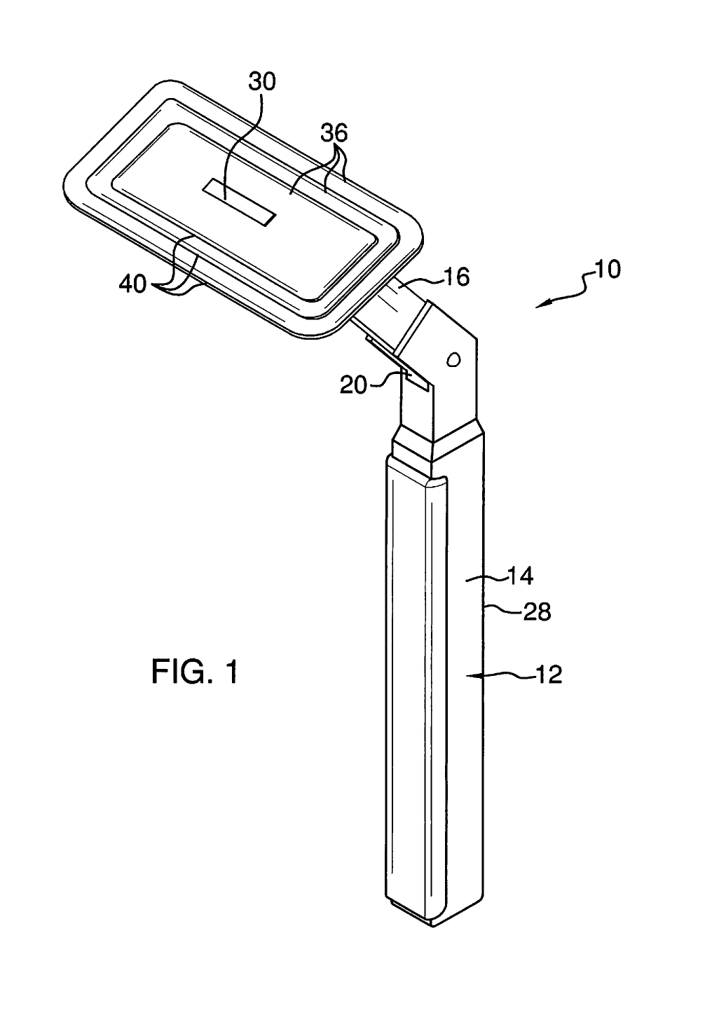

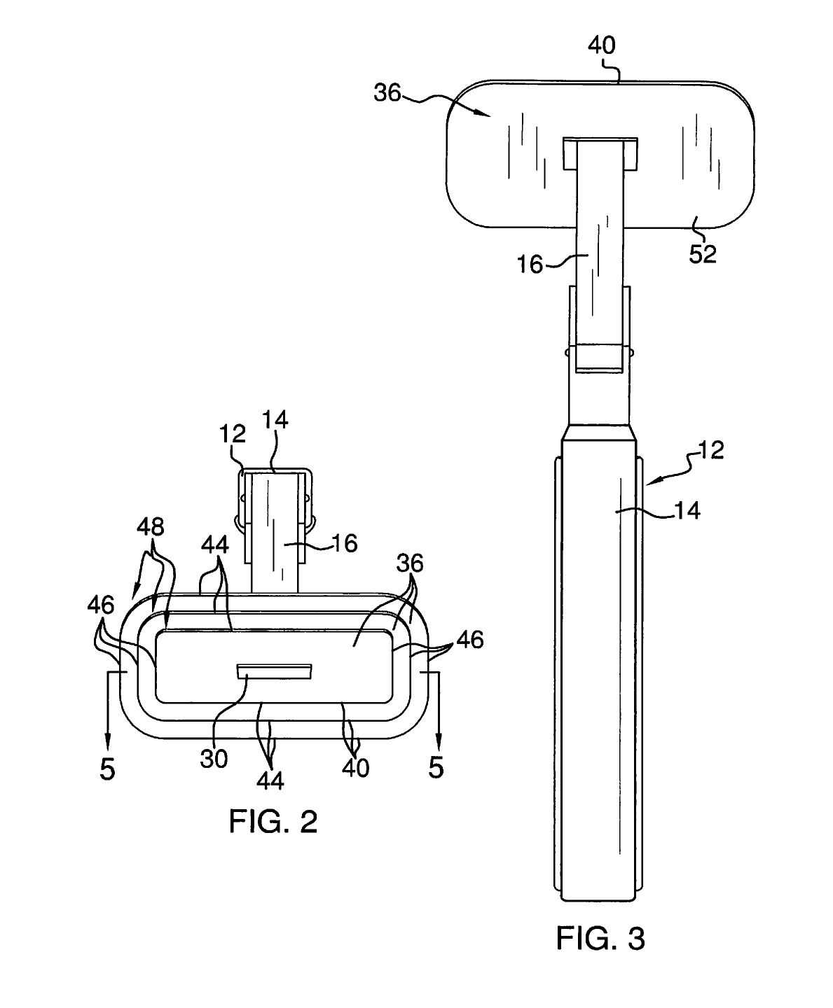

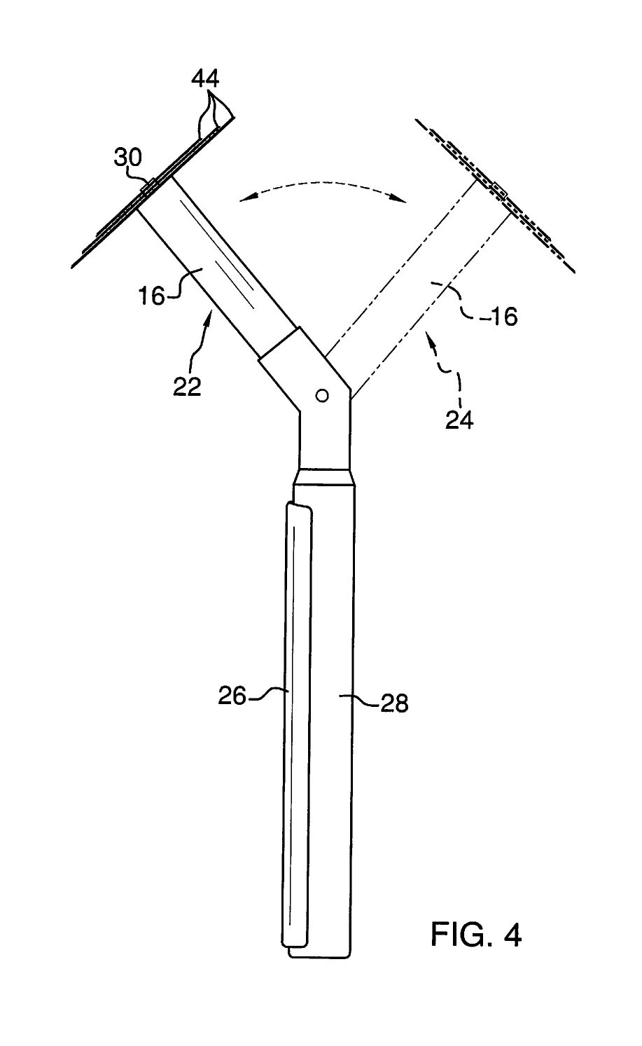

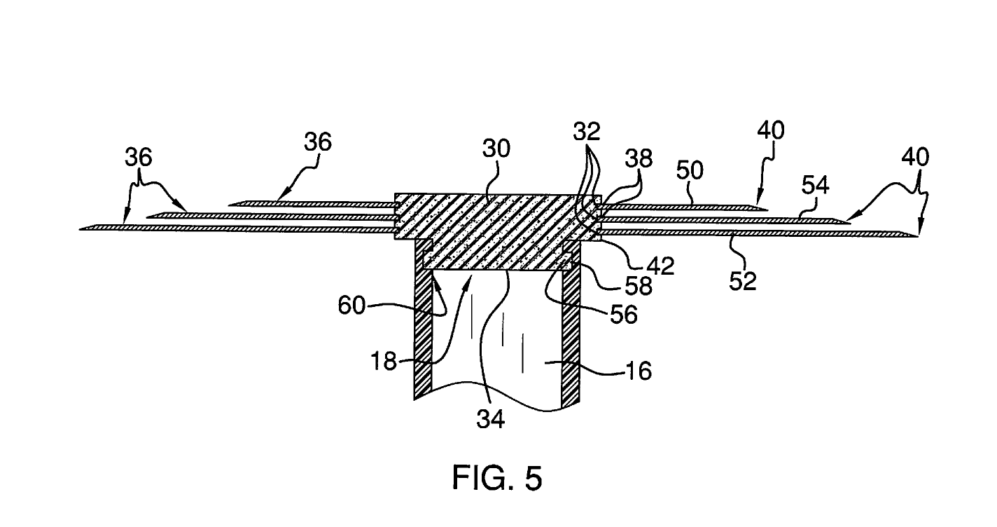

With reference now to the drawings, and in particular to FIGS. 1 through 5 thereof, a new razor device embodying the principles and concepts of an embodiment of the disclosure and generally designated by the reference numeral 10 will be described.

As best illustrated in FIGS. 1 through 5, the razor assembly 10 generally comprises a handle 12 having a grip section 14 and an extension section 16. The extension section 16 has an open distal end 18 relative to the grip section 14. The extension section 16 also has a proximal end 20 relative to the grip section 14. The proximal end 20 is pivotally coupled to the grip section 14. The extension section 16 is pivotable between a first position 22 and a second position 24. The extension section 16 forms an obtuse angle less than 180 degrees with respect to a front side 26 of the grip section 14 in the first position 22. The extension section 16 forms an obtuse angle less than 180 degrees with a back side 28 of the grip section 14 in the second position 24.

A rubber head 30 is coupled to the extension section 16. A plurality of ridges 32 extend into the head 30. The head 30 may have a connection portion 34 inserted into the open distal end 18 of the extension section 16. A plurality of generally rectangular blades 36 is provided. Each blade 36 has an inner edge 38 positioned in an associated one of the ridges 32 whereby each blade 36 is fixedly coupled to the head 30. Each blade 36 has a sharp peripheral edge 40 extending fully around the blade 36 to facilitate shaving with the blade 36 at any angle. The sharp peripheral edge 40 of each blade 36 is outwardly positioned with respect to an outermost edge 42 of the head 30. The sharp peripheral edge 40 of each blade 36 may have a pair of opposed straight longitudinal sides 44 and a pair of opposed straight short sides 46. The sharp peripheral edge 40 of each blade 36 may also have a plurality of round corner sections 48 positioned between adjacent sides 44,46. Each blade 36 has a distinct size with respect to each other the blade 36. Thus, the sharp peripheral edge 40 of each blade 36 is offset from the sharp peripheral edge 40 of each adjacently positioned blade 36. The plurality of blades 36 may include a top blade 50, a bottom blade 52, and a medial blade 54 positioned between the top blade 50 and the bottom blade 52. The bottom blade 52 has the largest size between 12 and 14 millimeters between short sides 46, the top blade 50 the smallest size between 6 and 7 millimeters between short sides 46, and the medial blade 54 is sized between 9 and 10.5 millimeters between short sides 46. The difference in size may be proportional position the sharp peripheral edge 40 of the blades 36 on each side 44,46 in a plane.

A tongue 56 extends outwardly around the connection portion 34 of the head 30. A groove 58 extends inwardly into an inner face 60 of the extension portion 16 proximate the open distal end 20 of the extension section 16. The tongue 56 is received in the groove 58 whereby the head 30 is removably coupled to the handle 12 permitting periodic replacement of the blades 36.

In use, the grip section 14 is grasped and the head 30 manipulated pushing the sharp peripheral edges 40 against and along skin to shave the skin. The blades 36 may be moved in any desired direction to cut without having to remove the blades 36 from contacting the skin. The fixed nature of the head 30 promotes use of one of the longitudinal sides 44. When desired, the extension section 16 may be pivoted to permit use of the opposite side longitudinal side 44 to extend time between replacing the head 30 and blades 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A razor assembly comprising:
a handle having a grip section and an extension section;
a head coupled to said extension section; and
a plurality of blades coupled to said head, each said blade having a sharp peripheral edge extending fully around said blade, said sharp peripheral edge of each said blade being outwardly positioned with respect to an outermost edge of said head.

2. The assembly of claim 1, further comprising:
said extension section having an open distal end relative to said grip section; and
said head having a connection portion, said connection portion being inserted into said open distal end of said extension section.

3. The assembly of claim 2, further comprising:
a tongue extending outwardly around said connection portion of said head; and
a groove extending inwardly into an inner face of said extension portion proximate said open distal end of said extension section, said tongue being received in said groove whereby said head is coupled to said handle.

4. The assembly of claim 1, further including said extension section having a proximal end relative to said grip section, said proximal end being pivotally coupled to said grip section.

5. The assembly of claim 4, further including said extension section being pivotable between a first position and a second position wherein said extension section forms an obtuse angle less than 180 degrees with respect to a front side of said grip section in said first position and said extension section forms an obtuse angle less than 180 degrees with a back side of said grip section in said second position.

6. The assembly of claim 1, further including said head being constructed of rubber.

7. The assembly of claim 1, further including said sharp peripheral edge of each said blade having a pair of opposed straight longitudinal sides and a pair of opposed straight short sides.

8. The assembly of claim 7, further including said sharp peripheral edge of each said blade having a plurality of round corner sections.

9. The assembly of claim 1, further including each said blade having a distinct size with respect to each other said blade whereby said sharp peripheral edge of each said blade is offset from said sharp peripheral edge of each adjacently positioned said blade.

10. The assembly of claim 9, further including said plurality of blades including a top blade, a bottom blade, and a medial blade positioned between said top blade and said bottom blade.

11. The assembly of claim 1, further including said plurality of blades being positioned in parallel planes.

12. The assembly of claim 1, further comprising:
a plurality of ridges extending into said head; and
each said blade having an inner edge positioned in an associated one of said ridges whereby each said blade is fixedly coupled to said head.

13. A razor assembly comprising:
a handle having a grip section and an extension section, said extension section having an open distal end relative to said grip section, said extension section having a proximal end relative to said grip section, said proximal end being pivotally coupled to said grip section, said extension section being pivotable between a first position and a second position wherein said extension section forms an obtuse angle less than 180 degrees with respect to a front side of said grip section in said first position and said extension section forms an obtuse angle less than 180 degrees with a back side of said grip section in said second position;
a rubber head coupled to said extension section, a plurality of ridges extending into said head, said head having a connection portion, said connection portion being inserted into said open distal end of said extension section;
a plurality of blades, each said blade having an inner edge positioned in an associated one of said ridges whereby each said blade is fixedly coupled to said head, each said blade having a sharp peripheral edge extending fully around said blade, said sharp peripheral edge of each said blade being outwardly positioned with respect to an outermost edge of said head, said sharp peripheral edge of each said blade having a pair of opposed straight longitudinal sides and a pair of opposed straight short sides, said sharp peripheral edge of each said blade having a plurality of round corner sections, each said blade having a distinct size with respect to each other said blade whereby said sharp peripheral edge of each said blade is offset from said sharp peripheral edge of each adjacently positioned said blade, said plurality of blades including a top blade, a bottom blade, and a medial blade positioned between said top blade and said bottom blade, said plurality of blades being positioned in parallel planes;
a tongue extending outwardly around said connection portion of said head; and
a groove extending inwardly into an inner face of said extension portion proximate said open distal end of said extension section, said tongue being received in said groove whereby said head is coupled to said handle.
